(19) United States
(12) Patent Application Publication
(10) Pub. No.: US 2024/0293787 A1
(43) Pub. Date: Sep. 5, 2024

(54) CATALYTIC HEAT EXCHANGE REACTOR WITH HELICAL FLOW

(71) Applicant: Topsoe A/S, Kgs. Lyngby (DK)

(72) Inventors: Anders Helbo Hansen, Espergærde (DK); Kristian Bjarklev, Kgs. Lyngby (DK); Michael Boe, Klampenborg (DK)

(73) Assignee: Topsoe A/S, Kgs. Lyngby (DK)

(21) Appl. No.: 18/271,197

(22) PCT Filed: Jan. 27, 2022
(86) PCT No.: PCT/EP2022/051865

§ 371 Date: Jul. 6, 2023

(30) Foreign Application Priority Data
Jan. 28, 2021 (EP) 21153969.7

(51) Int. Cl. B01J 8/06

(52) U.S. Cl. CPC B01J 8/067; B01J 2208/00194; B01J 2208/00221

(57) ABSTRACT

The present invention relates to a catalytic heat exchange reactor for carrying out endothermic or exothermic catalytic reactions with at least one helical upward flow around the heat transfer tubes and a central mixed gas tube.

The present invention relates to a catalytic heat exchange reactor for carrying out endothermic or exothermic catalytic reactions. In particular, the present invention relates to a catalytic heat exchange reactor where at least a part of the fluid flow is helical, which improves and balances the heat transfer. The catalytic heat exchange reactor may be part of a large plant, such as a production plant for chemicals.

Catalytic reactors for carrying out endothermic or exothermic reactions are well known in the art; particular examples are reactors for the endothermic steam reforming of hydrocarbons and reactors for the exothermic methanol synthesis reactions (not limiting the scope of the invention to these reactions). The reactions are typically carried out in tubes loaded with a suitable solid catalyst through which a process gas stream comprising the reactants is passed at elevated pressure. A plurality of tubes is arranged in the reactor. The tubes run in parallel along the major axis of the catalytic reactor, while a heat-exchanging medium outside the tubes heats or cools the tubes. The solid catalyst inside the tubes provides a catalyst bed in which the required chemical reactions take place. The catalyst can be provided as solid particles or as a coated structure, for example as a thin layer fixed on the inner wall of the tubes in steam reforming reactors or/and as a thin layer fixed to structures such as metal structures arranged within the tubes.

In another reactor configuration comprising a plurality of tubes the solid catalyst particles may be disposed outside said tubes, hereinafter also referred to as heat transfer tubes, whilst the heat exchanging medium passes inside. The solid catalyst outside the heat transfer tubes provides the catalyst bed in which the required chemical reactions take place.

Further types of heat transfer tubes and heat exchange reactors are known in the art. In the following, the invention is explained with reference to catalytic heat exchange reactors and heat transfer tubes with the catalysts arranged inside the tubes and where the tubes and reactor is arranged substantially vertically. However, the scope of the invention is not limited to these type of tubes and reactors. The terms “catalytic reactor”, “heat exchange reactor” and “reactor” are used interchangeably. By “catalyst bed” is meant the volume of catalyst forming said bed and which is inside the heat transfer tubes. The terms “heat transfer tubes” and “tubes” are used interchangeably and cover the tubes which are in contact with catalyst as well as a heat exchanging medium for the purpose of carrying out catalytic reactions.

A process and reactor in which a catalyst is in indirect contact with a heat exchanging medium is known from EP0271299. This citation discloses a reactor and process that combines steam reforming and autothermal reforming. The steam reforming zone arranged in the lower region of the reactor comprise a number of tubes with catalyst disposed inside while on the upper region of the reactor an autothermal reforming catalyst is disposed outside the steam reforming tubes. EP-A-1 106 570 discloses a process for steam reforming in parallel connected tubular reformers (reactors) comprising a number of steam reforming tubes and being heated by indirect heat exchange. The catalyst is disposed in one reactor outside the steam reforming tubes and inside the steam reforming tubes in the other reactor.

WO0156690 describes a heat exchange reactor including an outer shell provided with process gas inlet and outlet ports, a plurality of reactor tubes supported at their upper ends, header means for supplying process gas from said header inlet port to the upper ends of the reactor tubes, said means including two or more primary inlet headers disposed across the upper part of said shell, each primary inlet header having a depth greater than its width, whereby said tubes are supported, relative to the shell directly or indirectly by said primary inlet headers.

EP1048343A discloses a heat-exchanger type reactor which has a plurality of tubes holding a catalyst, a shell section through which a heat-transfer medium is passed to carry out heat-transfer with a reaction fluid in said tubes, and upper and lower tube sheets, the upper ends of said tubes being joined to said upper tube sheet by way of first expansion joints fixed to the upper side of said upper tube sheet, the lower ends of said tubes being fixed directly to the floatable lower tube sheet, a floatable room being formed which is partitioned by said lower tube sheet and an inner end plate (inner head) joined to the lower side thereof and has an opening in the lower part, and said opening being joined by way of a second expansion joint to a tube-side outlet to the outside of the reactor.

WO2006117572 describes an apparatus for steam reforming of hydrocarbons comprising a heat exchange reformer having disposed within a plurality of vertical catalyst-filled tubes, through which a gas mixture comprising hydrocarbon and steam may be passed, and to which heat may be transferred by means of a heat exchange medium flowing around the external tube surfaces, characterized in that one or more helical baffles are provided within the reformer such that the heat exchange medium follows a helical path through the reformer. A process for steam reforming of hydrocarbons using the apparatus is also described.

U.S. Pat. No. 3,400,758 discloses a tube and shell type heat exchanger, wherein the shell side fluid is caused to flow over the tubes in a helical path, baffle means being provided in the form of longitudinally spaced segmental plate elements having flow control surfaces which are perpendicular to the axes of the tubes simplifying installation and removal of the tubes.

U.S. Pat. No. 4,357,991 describes A heat exchanger having a disc and doughnut baffle configuration, in which the tubes are laid out in a set of concentric rings. Each ring of a set contains the same number of tubes as each other ring of the set, and the tubes in each ring are spaced uniformly apart. Each tube in each ring is located circumferentially midway between the two adjacent tubes of each neighboring ring and is separated from each of the two adjacent tubes in each adjacent ring by a ligament distance h. The distance h is held constant for all tubes in the set, by varying the radial spacing between rings, and the distance between any two adjacent tubes in any ring of the set is made greater than or equal to 2 h. The ligament gaps h which are constant therefore determine the minimum flow area between adjacent rings, and therefore the mass flow velocity through the tube bundle is constant.

U.S. Pat. No. 3,731,733 discloses a cylindrical enclosure with a central tubular nucleus and in between these, a first fluid flows following at least two parallel overlapping pseudo-helical paths which entirely occupy the volume between the enclosure and the nucleus. The paths are guided by vertical radial partitions and horizontal baffles. The baffles are interconnected by the radial partitions in twos (helical double-flow baffling) or in threes (helical triple-flow baffling) and have segmented cut-outs staggered in succession relative to one another. Also provided in the space between the enclosure and the nucleus and working in combination with the flow paths is a series of parallel tubes in which a second fluid flows, said tubes passing through the baffles. This exchanger allows not only a higher thermal performance as a result of better guidance of the fluid and at the same time a higher out-put, but also a considerable mechanical improvement by reduction of the range of the tubes of the tube-groups.

EP1668306 describes a heat exchanger which is configured to have quadrant shaped baffles positioned at an angle to a longitudinal axis of shell for guiding cross-flow of fluid into a helical pattern while maintaining substantially uniform velocity of the crossflow.

Despite the known art, there is a need for a catalytic heat exchange reactor which provides a lower cost solution to the task of utilizing the waste heat of a primary reforming process for additional reforming. Furthermore, there is a need for a catalytic heat exchange reactor with a lower production cost than the current designs. Also, there is a need for a catalytic heat exchange reactor which reduces the amount of material needed for the heat transfer tubes.

It is an object of the present invention to provide a catalytic heat exchange reactor which solves the mentioned problems and as will be explained has a further number of advantages.

This is achieved by a catalytic heat exchange reactor according to the present invention as described in the following description and claims. Accordingly, the present invention comprises a catalytic heat exchange reactor with a helical flow on the shell side of the heat transfer tubes which is designed to provide almost the same heat transfer to all heat transfer tubes i.e. to balance the heat transfer, since this is needed for the catalytic chemical reaction to be performed optimally.

To provide the same heat transfer to all heat transfer tubes is difficult because the flow wants to predominantly run the shortest distance by spiraling upwards in the catalytic heat exchange reactor near the center (that is, on a smaller diameter). Hereby the tubes located closer to the center get too much heat, and the tubes near the outer shell gets too little heat.

The catalytic heat exchange reactor according to this invention is designed as a shell-and-tube heat exchanger with catalyst in the heat transfer tubes. It has a single-tube design where each heat transfer tube is a single tube (as opposed to for instance the more complex concentric double tube). In an embodiment, it has a staircase baffle setup, zig-zag tube pattern, flow restriction plates near the outer periphery of the tube bundle and a center tube replacing an external return flow transfer line.

The flow path in the catalytic heat exchange reactor is as follows: Process gas is introduced in the top of a heat transfer tube bundle, where it passes through catalyst arranged in the tubes. The now reformed gas is mixed in the bottom of the reactor with hotter heat exchange gas (for instance from an ATR), which brings it up in temperature.

5 The mixed gas is then passed through the shell-side of the heat transfer tubes, in an embodiment in two helical flows, where it transfers heat to the tubes and thus the endothermic process within the tubes, before it is lead into the center of the catalytic heat exchange reactor at the top (beneath a tube sheet) and brought down and out of the reactor through a central mixed gas tube.

The single-tube design according to the present invention lowers the cost compared to current catalytic heat exchange reactor designs. Furthermore, the simple geometry of the tubes allows for much narrower (small diameter) heat transfer tubes than possible in other types of known heat exchange reactors. This reduces the amount of material 15 needed for the heat transfer tubes. Helical flow in the catalytic heat exchange reactor allows for a more compact reactor design solution with a low pressure drop for the same duty, compared to other solutions. In an embodiment with baffles arranged in a spiral staircase manner, the staircase design allows the baffle system to be made by assembling straight metal sheets, simplifying the production. Using many small steps 20 pr. rotation decreases the pressure drop, compared to few large steps. An embodiment with a staircase design allows a varying baffle distance along the length of the transfer tube bundle. This can be used to maintain or increase the mixed gas velocity as the flow is cooled along the tube bundle, by gradually decreasing the baffle distance, thus decreasing the flow channel cross-section area. However, the present invention will also work with a fixed baffle distance. In an embodiment with a transfer tube layout in zigzag pattern and/or flow restriction plates on the outside of the transfer tube bundle, the layout and the flow restriction plates even out the flow, so that the tube-to-tube heat flux variation is reduced. A central mixed gas tube collects the mixed gas from the top of the catalytic heat exchange reactor and brings the mixed gas to the bottom and out 30 of the reactor. This eliminates the need of an external return transfer line, thus saving both space and costs. In an embodiment, an outer and/or an inner shroud are used for holding baffles in place, rather than using tie rods. In an embodiment with an inner shroud, the inner shroud located around the central mixed gas tube is perforated, to eliminate a thermal by-pass flow to the inlet of the central mixed gas tube in the space between the inner shroud and the central gas mixed tube. The perforation secures that the gas flowing in the space between inner shroud and central gas mixed tube is constantly mixed/exchanged with the gas flowing in the helical flow. Thus, all the mixed gas is forced through the transfer tube bundle, and the need for a stuffing box between inner shroud and central gas mixed tube is eliminated or reduced.

In an embodiment of the invention a catalytic heat exchange reactor for carrying out endothermic or exothermic catalytic reactions comprises a shell with a cylindrical section. The cylindrical section comprises the major part of the catalytic heat exchange reactor and is in most cases oriented in a vertical position. Within the shell, a plurality of vertical heat transfer tubes is arranged. The heat transfer tubes are at least partly filled with catalyst, the catalyst may be in the form of pellets in any shape, in the form of catalyzed hardware structures and/or catalytic coating on the inside of the heat transfer tubes as mentioned in the above. Through the catalyst filled heat transfer tubes a process gas may be passed from the upper end of the heat transfer tubes, through the tubes and to the lower end of the heat transfer tubes. The catalytic heat exchange reactor further comprises at least one upper process gas inlet providing flow passage of the process gas to the upper end of the heat transfer tubes. The upper process gas inlet may be located in the upper part of the cylindrical shell or above, in an upper part of the shell. Further the catalytic heat exchange reactor comprises at least one lower heat exchange gas inlet and at least one lower mixed gas outlet, both of which may be located in the shell below the heat transfer tubes. An upper tube sheet is arranged in the upper part of the shell, either in the upper part of the cylindrical section or above it. The upper tube sheet is adapted to support the plurality of heat transfer tubes. The support may be a free sliding support only supporting the heat transfer tubes in a horizontal direction but allowing for vertical movement; or it may be a fixed support of the heat transfer tubes, such as a weld, thread, or any known fixed support. An example of a sliding support is apertures in the upper tube sheet which have a diameter slightly larger than the outer diameter of the heat transfer tubes, thus allowing the heat transfer tubes to perform vertical but almost no horizontal movement relative to the upper tube sheet, another example could be a stuffing box. A plurality of baffles is arranged within the shell, below the upper tube sheet. The baffles have apertures adapted to support the plurality of heat transfer tubes. Like the upper tube sheet, the baffle support of the heat transfer tubes may be a fixed or a sliding support, or some of the supports may be fixed and other sliding supports. The baffles provide flow passage of a mixed gas comprising heat exchange gas from the lower heat exchange gas inlet and reformed gas exiting the lower end of the heat transfer tubes in at least one helical upward flow within the shell and around the outer side of each of the heat transfer tubes. The construction of the baffles and their arrangement within the shell and around the heat transfer tubes guides the mixed gas flow in the at least one helical upward flow. Different embodiments of this arrangement and construction will be specified in the following, but this embodiment is not restricted to one single construction and arrangement of the baffles and this embodiment also encompasses one or more helical separate upward flows within the shell. The catalytic heat exchange reactor further comprises a central mixed gas tube arranged vertically in the center of the shell with a top inlet end and a bottom outlet end. The central mixed gas tube provides a flow passage of the mixed gas from the top of the at least one helical upward flow adjacent the lower side of the upper tube sheet to the lower mixed gas outlet. Accordingly, when the at least one helical upward flow reaches the lower side of the upper tube sheet, it cannot flow further in the upward helical direction; instead it is forced into the central mixed gas tube via the top inlet of the central mixed gas tube. From the top inlet, the mixed gas flows down through the central mixed gas tube and out of the central mixed gas tube via the bottom outlet end.

Thus, the center of the catalytic heat exchange reactor, which is not very effective for heat exchange in the case of a helical flow, is utilized for a return flow of the mixed gas. In known art heat exchange reactors this is normally handled by an external transfer line, which is expensive and takes up considerable space as it also has to be thermally insulated. So, the catalytic heat exchange reactor according to the present invention combines the advantages of helical upward flow(s) around the heat exchange tubes to enhance and even-out the heat exchange with the advantages described in the above of the central flow return tube.

In an embodiment of the invention, the catalytic heat exchange reactor of the invention is a steam reforming of hydrocarbons catalytic heat exchange reactor. In a further embodiment of the invention the plurality of baffles is arranged in at least one helix. The at least one helix is arranged to provide the above mentioned helical upward flow, it is however to be understood that the invention is not restricted to this embodiment, as other arrangements of the plurality of baffles may provide the upward helical flow(s), for instance horizontal baffles with angled surfaces (like propellers) and other arrangements.

In an embodiment of the invention, the at least one helical upward flow goes around the central mixed gas tube and the baffles comprise sets of horizontal and vertical segments arranged as a spiral staircase. As the mixed gas flows from the lower end of the shell between the heat transfer tubes, the flow meets the baffles arranged in a spiral staircase and it is therefore forced in an upward helical motion to flow from the lower part of the shell to the upper part of the shell; before it meets the lower side of the upper tube sheet and is forced inwards and into the top inlet end of the central mixed gas tube. The embodiment with baffles comprising sets of horizontal and vertical segments has, among other, the advantage that the baffles can be easily manufactured with a low cost as a consequence, and also the mounting and installing of heat transfer tubes and baffles is simplified.

In an embodiment of the invention, the plurality of baffles is arranged and adapted to provide one to four helical upward flows, preferably two helical upward flows. For instance, if two helical upward flows are preferred according to the process and other preconditions, the plurality of baffles may be arranged as two spiral staircases, the lower end of one spiral staircase being arranged 180 degrees rotated to the lower end of the other spiral staircase.

In an embodiment of the invention, a complete 360 degree turn of the at least one helical upward flow comprises two to sixteen sets of baffles, preferably eight sets of baffles. The number of baffles chosen for a complete 360-degree turn depend on the specific catalytic heat exchange reactor and the specific process, it may be varied depending on the demand to material and construction costs, pressure loss, heat transfer to name some of the parameters.

In an embodiment of the invention, the vertical distance between the baffles is smaller in the top of the at least one helical upward flow than in the bottom of the at least one helical upward flow. In the bottom of the shell, the mixed gas is relatively hot and therefore the density is relatively low; as the mixed gas passes up through the reactor in heat exchange relation with the heat transfer tubes, the mixed gas is cooled due to the endothermic reaction within the tubes and therefore the density rises. To compensate for this, the vertical distance between the baffles may be decreased up through the reactor, thus seeking to even out and retain the desired heat exchange. In an embodiment of the invention in relation to the above described, the vertical distance between the baffles is gradually reduced from the lower part of the at least one helical upward flow to the upper part of the at least one helical upward flow; i.e. from the lower part of the heat transfer tubes to the upper part of the heat transfer tubes. In a further embodiment of the invention, the vertical distance between the uppermost vertically adjacent baffles is less than 500 mm and the vertical distance between the lowermost vertically adjacent baffles is greater than 600 mm. For instance, in the case where the baffles have a staircase design, the distance between the uppermost step and the step vertically beneath it is less than 500 mm, whereas the distance between the lowermost step and the step vertically above it is more than 600 mm. The specific distances may be varied according to the specific process parameters and the specific catalytic heat exchange reactor which may vary from case to case, from customer to customer.

In an embodiment of the invention, the at least one helical upward flow performs between one to eight full 360 degree turns from the lower part to the upper part of the at least one helical upward flow. The described plurality of baffles is thus, arranged to restrict and force the mixed gas upward flow in at least one and up to eight full 360 degree turns from the lower end of the heat transfer tubes to the upper end of the heat transfer tubes, where the mixed gas flow meets the lower side of the tube sheet and is forced inwards and into the top inlet of the central mixed gas tube. As discussed, this may be achieved by different designs and arrangements of the baffles, for instance the staircase design. How many full 360 degree turns the mixed gas performs in the at least one helical upward flow is again dependent on the specific process parameters and the specific catalytic heat exchange reactor in question; as is the number of helical upward flows the catalytic heat exchange reactor is designed to have.

To further even out the heat exchange along a horizontal direction of the reactor, in an embodiment of the invention the distance between the vertical heat transfer tubes is shorter nearest the central mixed gas tube than nearest the periphery of the shell. As the mixed gas flow performs a helical upward flow movement, the gas will seek to “run the shortest distance” near the center of the reactor. To counter this and thereby even out the heat exchange of all the heat transfer tubes no matter if they are placed near the center or near the periphery of the shell, the distance between the tubes near the center is relatively smaller than the distance between the tubes near the periphery. Accordingly, in a further embodiment of this invention, the distance between the vertical heat transfer tubes is gradually reduced from nearest the periphery of the shell towards the central mixed gas tube. More specifically, in one embodiment of the invention the distance between the vertical heat transfer tubes is less than 50 mm nearest the central mixed gas tube and more than 100 mm nearest the periphery of the shell.

Also, to increase and even out the heat exchange between the mixed gas flowing outside the heat transfer tubes and the process gas within the heat transfer tubes, in an embodiment of the invention, the vertical heat transfer tubes are arranged in a zig-zag pattern when seen in a tangential direction of the shell. Thus, when seen from the direction of the upward helical flowing mixed gas, there is no straight, “easy and fast” route for the mixed gas to flow between the heat transfer tubes. Since the heat transfer tubes are arranged in a zig-zag pattern in a tangential direction of the shell, the helical flowing mixed gas will always be diverted as it meets the next heat transfer tube on its path, thus increasing the heat transfer.

In an embodiment of the invention, the catalytic heat exchange reactor further comprises an inner shroud surrounding and adjacent to the central mixed gas tube. The inner shroud is fixed to the upper tube sheet and is adapted to support at least some of the plurality of baffles. Thus, the inner shroud may support the plurality of baffles. In an embodiment of the invention, the inner shroud is perforated. The perforations have the effect that gas which would seek to bypass in a space between the central mixed gas tube and the inner shroud will be mixed with the mixed gas, minimizing thermal by-pass and eliminating or at least minimizing the need for a stuffing box. In a further embodiment of the invention, the inner shroud may comprise flow restrictors, such as flow restriction plates, to prevent tangential by-pass of the mixed gas and thus enhance the heat transfer in the reactor.

In an embodiment of the invention, the catalytic heat exchange reactor comprises also an outer shroud arranged within and adjacent to the shell and adapted to provide support for at least some of the baffles. As the shrouds supports the baffles, the baffles may support the heat transfer tubes as earlier described. The outer shroud may in an embodiment comprise flow-restriction plates with the effect as described earlier in relation to the inner shroud

In an embodiment of the invention the catalyst within the heat transfer tubes comprises particles and the vertical heat transfer tubes have an inside diameter which is between 1 to 1.9 times the largest outer dimension of a catalyst particle. Thus, the heat transfer tubes may be constructed very narrow to each only support one catalyst particle in a horizontal cross section. This may be advantageous for the heat exchange and catalytic process and it is made possible or feasible due to the simple geometry of the tubes (not double tubes), allowing for much narrower tubes than known in the art. It is to be understood that also other embodiments such as an embodiment where the vertical heat transfer tubes have an inside diameter which is between 1 to 3.5 times the largest outer dimension of a catalyst particle may be used.

Thus, the heat exchange reactor according to the present invention provides a much more compact reactor design than known in the art as it does not use any volume for flow turns, has less shadow effect (where flow on the lee side, behind structures is not optimal) and has a more uniform heat transfer to tubes among other because of the helical flow and the central mixed gas tube.

Features of the invention

1. A catalytic heat exchange reactor for carrying out endothermic or exothermic catalytic reactions comprising,
a shell with a cylindrical section
a plurality of vertical heat transfer tubes, at least partly filled with catalyst and arranged within said shell and through which a process gas may be passed from the upper end of the heat transfer tubes to the lower end of the heat transfer tubes
at least one upper process gas inlet providing flow passage of the process gas to the upper end of the heat transfer tubes
at least one lower heat exchange gas inlet
at least one lower mixed gas outlet
an upper tube sheet supporting the plurality of heat transfer tubes
a plurality of baffles arranged within the shell, below the upper tube sheet, with apertures adapted to support the plurality of heat transfer tubes and adapted to provide flow passage of a mixed gas comprising heat exchange gas from the lower heat exchange gas inlet and reformed gas exiting the lower end of the heat transfer tubes in at least one helical upward flow within the shell and around the outer side of each of the heat transfer tubes,
   wherein the catalytic heat exchange reactor further comprises a central mixed gas tube arranged vertically in the center of the shell with a top inlet end and a bottom outlet end, adapted to provide a flow passage of the mixed gas from the top of the at least one helical upward flow adjacent the lower side of the upper tube sheet to the lower mixed gas outlet.

2. A catalytic heat exchange reactor according to feature 1, wherein the catalytic heat exchange reactor is a steam reforming of hydrocarbons catalytic heat exchange reactor.

3. A catalytic heat exchange reactor according to any of the preceding features, wherein the plurality of baffles are arranged in at least one helix.

4. A catalytic heat exchange reactor according to any of the preceding features, wherein the at least one helical upward flow goes around the central mixed gas tube and the baffles comprise sets of horizontal and vertical segments arranged as a spiral staircase.

5. A catalytic heat exchange reactor according to any of the preceding features, wherein the plurality of baffles are arranged and adapted to provide 1-4 helical upward flows, preferably two helical upward flows.

6. A catalytic heat exchange reactor according to feature 4 or 5, wherein a complete 360 degree turn of the at least one helical upward flow comprises 2 to 16 sets of baffles, preferably 8 sets of baffles.

7. A catalytic heat exchange reactor according to any of the preceding features, wherein the vertical distance between the baffles is smaller in the top of the at least one helical upward flow than in the bottom of the at least one helical upward flow.

8. A catalytic heat exchange reactor according to any of the preceding features, wherein the vertical distance between the baffles is gradually reduced from the lower part of the at least one helical upward flow to the upper part of the at least one helical upward flow.

9. A catalytic heat exchange reactor according to any of the preceding features, wherein the vertical distance between the uppermost vertically adjacent baffles is less than 500 mm and the vertical distance between the lowermost vertically adjacent baffles is greater than 600 mm.

10. A catalytic heat exchange reactor according to any of the preceding features, wherein the at least one helical upward flow performs between 1-8 full 360 degree turns from the lower part to the upper part of the at least one helical upward flow.

11. A catalytic heat exchange reactor according to any of the preceding features, wherein
the distance between the vertical heat transfer tubes is shorter nearest the central mixed gas tube than nearest the periphery of the shell.

12. A catalytic heat exchange reactor according to any of the preceding features, wherein the distance between the vertical heat transfer tubes is gradually reduced from nearest the periphery of the shell towards the central mixed gas tube.

13. A catalytic heat exchange reactor according to any of the preceding features, wherein the distance between the vertical heat transfer tubes is less than 50 mm nearest the central mixed gas tube and more than 100 mm nearest the periphery of the shell.

14. A catalytic heat exchange reactor according to any of the preceding features, wherein the vertical heat transfer tubes are arranged in a zig-zag pattern when seen in a tangential direction of the shell.

15. A catalytic heat exchange reactor according to any of the preceding features, further comprising an inner shroud surrounding and adjacent to the central mixed gas tube, fixed to the upper tube sheet and adapted to support at least some of the plurality of baffles.

16. A catalytic heat exchange reactor according to feature 15, wherein the inner shroud is perforated.

17. A catalytic heat exchange reactor according to any of the preceding features, further comprising an outer shroud arranged within and adjacent to the shell and adapted to provide support for at least some of the baffles.

18. A catalytic heat exchange reactor according to feature 15, 16 or 17, wherein the inner shroud, the outer shroud or both the inner and outer shroud comprise flow-restriction plates.

5 19. A catalytic heat exchange reactor according to any of the preceding features, wherein the catalyst comprises particles and the vertical heat transfer tubes have an inside diameter which is between 1 to 1.9 times the largest outer dimension of a catalyst particle.

The present invention will be discussed in more detail with reference to some embodiments of the invention as shown in the drawings in which:

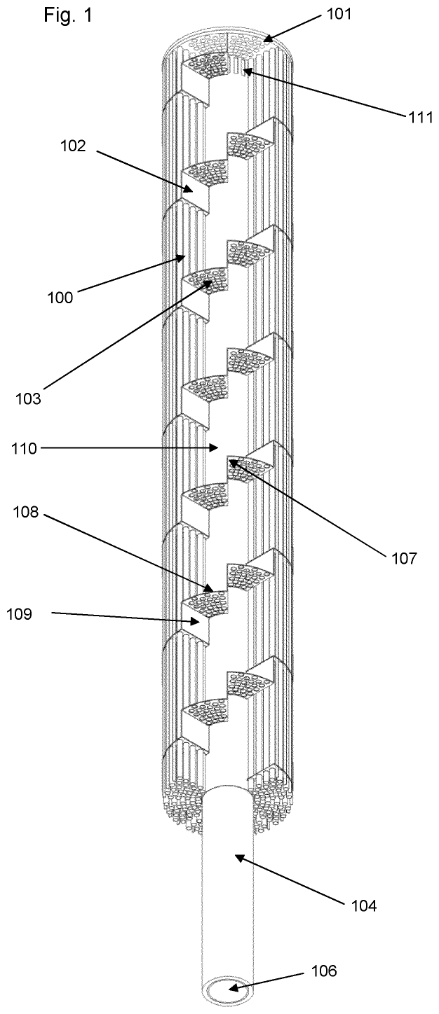

FIG. 1 is a partly cut isometric side view of some of the internals in a catalytic heat exchange reactor according to an embodiment of the invention,

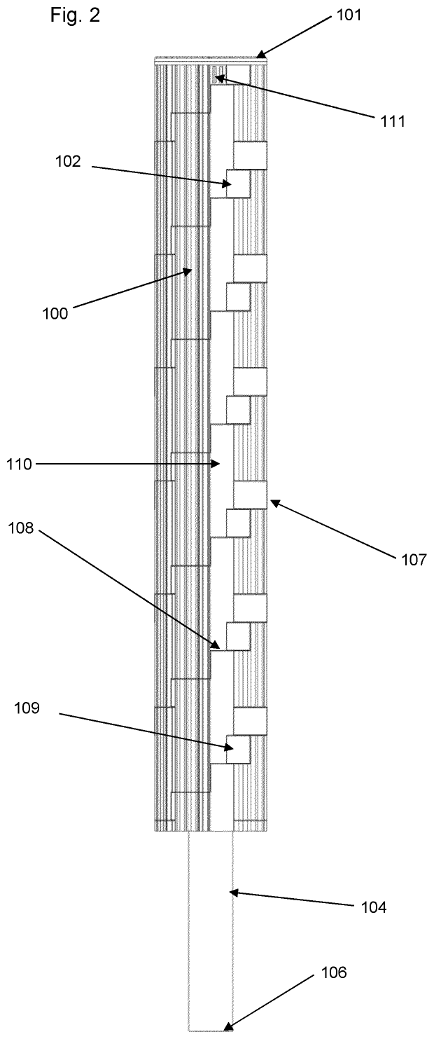

FIG. 2 is a partly cut side view of some of the internals according in a catalytic heat exchange reactor according to an embodiment of the invention,

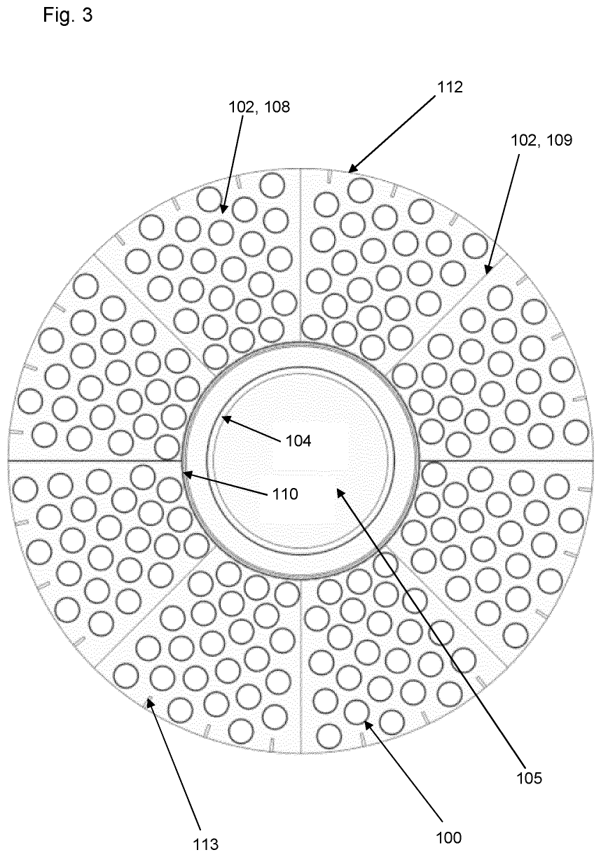

FIG. 3 is a cross sectional view of some of the internals in a catalytic heat exchange reactor according to an embodiment of the invention.

### Position Number Overview

100. heat transfer tubes
101. upper tube sheet
102. baffles
103. baffle aperture
104. central mixed gas tube
105. top inlet end
106. bottom outlet end
107. helix
108. horizontal segment
109. vertical segment
110. inner shroud
111. inner shroud outlet apertures
112. outer shroud
113. flow restriction plates

It is to be understood that the following are only some specific embodiments of the invention. As also discussed in the above, further embodiments are covered of the invention for instance a range of other baffle designs which provides the helical upward flow.

In FIG. 1, some of the internals of a catalytic heat exchange reactor reactor for carrying out endothermic or exothermic catalytic reactions according to an embodiment of the invention is shown in a partly cut isometric side view (some of the heat transfer tubes are cut out to more clearly show other parts of the internals). It is to be understood that the internals shown are installed in a shell with a cylindrical section (not shown) as known in the art. A plurality of heat transfer tubes 100 are arranged at least in a part of the cylindrical section of the shell in a vertical position. The heat transfer tubes allow for a process gas to pass within them from the upper end to the lower end of the tubes—passing a catalyst (not shown) which at least partly fills the heat transfer tubes. The process gas is provided to the heat transfer tubes via at least one upper process gas inlet arranged in the upper part of the shell (not shown), further through an upper tube sheet 101 via apertures in the tube sheet which also surrounds and thus supports the heat transfer tubes. This support may be sliding (only supporting the heat transfer tubes against horizontal movement) or it may be fixed, supporting the heat transfer tubes both horizontal and vertical as discussed earlier. As can be seen, the heat transfer tubes are arranged closely together, but wide enough apart to allow for a gas to flow between them-around the outer side of the heat transfer tubes as will be discussed more in the following. The process gas passes down through the entire length of the heat transfer tubes and out through the lower ends of the heat transfer tubes in the lower part of the shell. Here the process gas is mixed with relative hot heat exchange gas entering in the lower part of the shell via at least one lower heat exchange gas inlet (not shown). The heat exchange gas mixes with the process gas, and the thus hot (relative to the process gas) mixed gas flows up through the shell around the outer side of the heat transfer tubes. The upward flow of the mixed gas is restricted and guided by a plurality of baffles 102. The baffles comprise sets of both horizontal segments 108 and vertical segments 109, in this embodiment arranged in approximately a helix 107, a spiral staircase shape, which restricts and guides the mixed gas flow in at least one helical upward flow within the shell and around the outer side of each of the heat transfer tubes, thereby ensuring an effective and even heat transfer from the hot mixed gas, through the heat transfer tube wall to the colder process gas within the heat transfer tubes, providing heat to the endothermic catalytic reaction(s) taking place in the at least partly catalyst filled heat transfer tubes. The spiral staircase shape of the baffles guides the flow in an almost ideal upward spiral movement, while at the same time allowing for a relative simple manufacture and install of the baffles and heat transfer tubes. The horizontal segments ensure a baffle surface which is perpendicular to the heat transfer tubes, and thus the apertures 103 in the baffles supporting and allowing pass-through of the heat transfer tubes may have a simple circular shape; the vertical segments may pass in-between the heat transfer tubes without the need for apertures. Furthermore, the staircase design allows for a cost-effective production, where two or more segments may be assembled in advance before installing in the catalytic heat exchange reactor, and the assembly of two segments may even for instance be a simple bend of a flat plate. The number of baffle steps/segments may be varied and chosen depending of the specific reactor size and process as a consideration between cost and optimal mixed gas flow among other factors. In this embodiment of the invention, at least a part of the baffles is fixed to a cylindrical inner shroud 110, arranged around a central axis of the shell. In the upper part, the inner shroud comprises inner shroud outlet apertures 111 which allows the mixed gas to pass when it reaches the top of the helix and further upward flow is blocked by the upper tube sheet to prevent the mixed gas to interact with the incoming process gas. Via the inner shroud outlet apertures, the heat exchanged, cooler mixed gas exits through the top inlet end 105 (seen on FIG. 3) of a central mixed gas tube 104. The central mixed gas tube allows the mixed gas to exit through its bottom outlet end 106, in the lower part of the catalytic heat exchange reactor. This obviate the need for an external transfer line to the reactor which would take up plant space and which would be considerably more expensive than the internal central mixed gas tube, as an external transfer line would need connections, insulation, supports and be designed with a heavy wall to withstand the full process pressure. The “cost” of the central mixed gas tube is also relatively low with reference to the heat exchange process, since the central part of the helical upward flow is the least effective part of the circular cross-sectional area for heat exchange.

FIG. 2 shows the same inventive embodiment of the catalytic heat exchange reactor only in a partly cut side view in-stead of an isometric side view. The features are the same as in FIG. 1, but in this side view it is clearer to see that this embodiment comprises two spiral staircase arranged baffles, since in the lowest part of the heat transfer tube bundle two horizontal baffle segments are shown, one 180 degrees rotated in a cross-sectional area relative to the other. Thus, in this embodiment the mixed gas flows in two helical upwards flows.

In FIG. 3, a cross sectional view shows a part of the catalytic heat exchange reactor according to an embodiment of the invention showing the features as described in the above with reference to FIG. 1 and FIG. 2 and some further features. Innermost in the circular design, the central mixed gas tube is seen as is (through the tube) its upper part forming the top inlet end 105 as described in the above. Around the central mixed gas tube, the inner shroud is seen, supporting the baffles as described before. The void between the central mixed gas tube and the inner shroud may be filled with thermal insulation. In this view, the arrangement of the heat transfer tubes is visible. It can be seen how the tubes to some extent are arranged in a zig-zag pattern, thus forcing the mixed gas to change direction constantly when flowing in a helical movement and enhancing the heat transfer. The arrangement of the heat transfer tubes however also facilitates room for the vertical baffle segments, in this embodiment eight places around 5 the circular cross section of the shell. A further shroud, an outer shroud 112 is also shown, as is flow restriction plates 113 arranged on the inner side of the cylindrical outer shroud, which restricts the mixed gas flow from by-pass of the heat transfer tubes in the outer periphery of the heat transfer tubes.

1. A catalytic heat exchange reactor for carrying out endothermic or exothermic catalytic reactions comprising;
a shell with a cylindrical section;
a plurality of vertical heat transfer tubes, at least partly filled with catalyst and arranged within said shell and through which a process gas may be passed from the upper end of the heat transfer tubes to the lower end of the heat transfer tubes;
at least one upper process gas inlet providing flow passage of the process gas to the upper end of the heat transfer tubes;
at least one lower heat exchange gas inlet;
at least one lower mixed gas outlet;
an upper tube sheet supporting the plurality of heat transfer tubes; and
a plurality of baffles arranged within the shell, below the upper tube sheet, with apertures adapted to support the plurality of heat transfer tubes and adapted to provide flow passage of a mixed gas comprising heat exchange gas from the lower heat exchange gas inlet and reformed gas exiting the lower end of the heat transfer tubes in at least one helical upward flow within the shell and around the outer side of each of the heat transfer tubes,
wherein the catalytic heat exchange reactor further comprises a central mixed gas tube arranged vertically in the center of the shell with a top inlet end and a bottom outlet end, adapted to provide a flow passage of the mixed gas from the top of the at least one helical upward flow adjacent the lower side of the upper tube sheet to the lower mixed gas outlet.

2. A catalytic heat exchange reactor according to claim 1, wherein the catalytic heat exchange reactor is a hydrocarbon steam reforming catalytic heat exchange reactor.

3. A catalytic heat exchange reactor according to claim 1, wherein the plurality of baffles are arranged in at least one helix.

4. A catalytic heat exchange reactor according to claim 1, wherein the at least one helical upward flow goes around the central mixed gas tube and the baffles comprise sets of horizontal and vertical segments arranged as a spiral staircase.

5. A catalytic heat exchange reactor according to claim 1, wherein the plurality of baffles are arranged and adapted to provide two helical upward flows.

6. A catalytic heat exchange reactor according to claim 4, wherein a complete 360 degree turn of the at least one helical upward flow comprises 2 to 16 sets of baffles.

7. A catalytic heat exchange reactor according to claim 1, wherein the vertical distance between the baffles is smaller in the top of the at least one helical upward flow than in the bottom of the at least one helical upward flow.

8. A catalytic heat exchange reactor according to claim 1, wherein the vertical distance between the baffles is gradually reduced from the lower part of the at least one helical upward flow to the upper part of the at least one helical upward flow.

9. A catalytic heat exchange reactor according to claim 1, wherein the vertical distance between the uppermost vertically adjacent baffles is less than 500 mm and the vertical distance between the lowermost vertically adjacent baffles is greater than 600 mm.

10. A catalytic heat exchange reactor according to claim 1, wherein the at least one helical upward flow performs between 1-8 full 360 degree turns from the lower part to the upper part of the at least one helical upward flow.

11. A catalytic heat exchange reactor according to claim 1, wherein the distance between the vertical heat transfer tubes is shorter nearest the central mixed gas tube than nearest the periphery of the shell.

12. A catalytic heat exchange reactor according to claim 1, wherein the distance between the vertical heat transfer tubes is gradually reduced from nearest the periphery of the shell towards the central mixed gas tube.

13. A catalytic heat exchange reactor according to claim 1, wherein the distance between the vertical heat transfer tubes is less than 50 mm nearest the central mixed gas tube and more than 100 mm nearest the periphery of the shell.

14. A catalytic heat exchange reactor according to claim 1, wherein the vertical heat transfer tubes are arranged in a zig-zag pattern when seen in a tangential direction of the shell.

15. A catalytic heat exchange reactor according to claim 1, further comprising an inner shroud surrounding and adjacent to the central mixed gas tube, fixed to the upper tube sheet and adapted to support at least some of the plurality of baffles.

16. A catalytic heat exchange reactor according to claim 15, wherein the inner shroud is perforated.

17. A catalytic heat exchange reactor according to claim 1, further comprising an outer shroud arranged within and adjacent to the shell and adapted to provide support for at least some of the baffles.

18. A catalytic heat exchange reactor according to claim 15, wherein the inner shroud, the outer shroud or both the inner and outer shroud comprise flow-restriction plates.

19. A catalytic heat exchange reactor according to claim 1, wherein the catalyst comprises particles and the vertical heat transfer tubes have an inside diameter which is between 1 to 1.9 times the largest outer dimension of a catalyst particle.
